(19) United States
(12) Patent Application Publication
(10) Pub. No.: US 2023/0219701 A1
(43) Pub. Date: Jul. 13, 2023

(54) MOBILE PLATFORM FOR THE AERIAL DELIVERY OF A LOAD BY DRONES

(71) Applicants: Nicolino DI CARLO, Firenze (IT); ABZERO SRL, Pisa (IT)

(72) Inventors: Nicolino DI CARLO, Firenze (IT); Giuseppe Roberto TORTORA, Pisa (IT); Andrea CANNAS, Lotzorai (IT)

(73) Assignees: Nicolino DI CARLO, Firenze (IT); ABZERO SRL, Pisa (IT)

(21) Appl. No.: 17/925,271

(22) PCT Filed: May 14, 2021
(86) PCT No.: PCT/IB2021/054145

§ 371 Date: Nov. 14, 2022

(30) Foreign Application Priority Data
May 15, 2020 (IT) 102020000011194

(51) Int. Cl. B64U 70/92; B64F 1/36

(52) U.S. Cl. CPC B64U 70/92; B64F 1/36; B64U 2101/60

(57) ABSTRACT

A mobile platform (100) for the aerial delivery of a load by drones comprising a landing plane (110) arranged to define a vertical axis y, at least one position sensor adapted measure a spatial orientation O of the vertical axis y with respect to a predetermined reference system S, a local control unit connected to said or each position sensor, a electric accumulator arranged to provide electric energy to said or each position sensor and to the local control unit. Furthermore, the local control unit is arranged to acquire the spatial orientation O of the vertical axis y, compare the spatial orientation O of the vertical axis y with a predetermined spatial orientation O′, generate a status of correct positioning when between the spatial orientation O and the predetermined spatial orientation O′ there is an angular deviation a lower than a predetermined value αₘₐₓ.

### FIELD OF THE INVENTION

The present invention relates to the field of home delivery of objects by drones.

In particular, the invention relates to a mobile platform for the landing of drones and a system for monitoring and managing delivery.

### DESCRIPTION OF THE PRIOR ART

As well known, the transport of loads by drones is now widespread and used in many areas, as it is faster, more efficient and more automatable than traditional transport.

For example, drone transport is starting to be used in the hospital sector to speed up the movement of perishable organic material, in the food sector for the delivery of consumer goods, and in the postal sector for home delivery of parcels.

One of the problems that arise in these air transport systems concerns the arrival of the drone at the point of delivery of the load, as it must allow the safe landing of the drone or, alternatively, the safe release of the transported load.

Some possible solutions are shown in https://www.microavia.com/ and https://www.valqari.com/, where the landing platforms allow the material to be unloaded into boxes that open upon arrival of the drone. These systems allow safe delivery of the load to public places, such as supermarket parking lots or condominium courtyards, but, given their size, they are inadequate for direct delivery to an apartment.

US2020079530 shows a landing platform that can be positioned outside a window and contains a hatch leading to a glove box. Upon arrival of the drone, a transmitter on the platform allows the drone to identify the load release point.

This system, although it is less cumbersome than the previous ones, nevertheless requires a stable fixing in correspondence with an external wall of the house. This involves, in fact, the disfigurement of the facades of the buildings, a high cost for the installation, as well as the immovability of the platform, which is constantly exposed to atmospheric agents and deteriorating substances such as, for example, animal excrement or fine dust, with consequent wear of the mechanical parts of the device. Moreover, even more importantly, the platform cannot be used to deliver the load to a place other than that of the installation, such as a different home or workplace.

In DE102019122135A1, a package delivery platform configured to receive a package containing magnetic material from a drone is described. In particular, the package delivery platform comprises a main body, a plurality of magnets arranged around the main body and a control unit configured to appropriately activate the plurality of magnets in order to fix the package to the main body.

However, even this solution requires stable fixing on the outside of the house and does not allow the platform to be transported and used in a place other than that of the installation.

### SUMMARY OF THE INVENTION

It is therefore a feature of the present invention to provide a mobile platform for the aerial delivery of a load by drones that allows it to be installed in a simple and removable way at a point of the house accessible by air, such as a window, a balcony, or a terrace.

It is also a feature of the present invention to provide such a platform that comprises sensors and electronic components to automate and secure the delivery of the load.

It is still a feature of the present invention to provide such a platform that has high autonomy and low energy consumption.

It is another aspect of the present invention to provide a system for the aerial delivery of a load that allows the various operational phases of delivery to be remotely monitored and managed.

These and other objects are achieved by a mobile platform for the aerial delivery of a load by drones comprising:
a landing plane defining a vertical axis y;
at least one position sensor arranged to measure the spatial orientation 0 of the vertical axis y with respect to a predetermined reference system S;
a local control unit connected to said or each position sensor;
an electric accumulator suitable for providing electric energy to said or each position sensor and to the local control unit;
whose main feature is that the local control unit is arranged to:
acquire the spatial orientation 0 of the vertical axis y;
compare the spatial orientation 0 of the vertical axis y with a predetermined spatial orientation 0′;
generate a status of correct positioning when between the spatial orientation 0 and the predetermined spatial orientation 0′ there is an angular deviation a lower than a predetermined value αₘₐₓ.

Advantageously, an antenna is provided for wireless communication of data by the local control unit.

In particular, there is α = 3 - 10°.

Advantageously, an electric power generation system, a solar panel or a motion current generator is provided.

Advantageously, the local control unit is also arranged to command the emission of a signal of correct positioning following the generation of the status of correct positioning.

In particular, the signal can be of the following type:
sound;
visual;
vibro-tactile;
a combination of the previous.

Advantageously, at least one motion sensor is provided arranged to detect accelerations of the mobile platform beyond a predetermined threshold.

In particular, the local control unit is arranged to:
going into a stand-by state when the motion sensor does not detect accelerations of the mobile platform for a predetermined period of time Δt;
being in an activity state when the motion sensor detects accelerations of the mobile platform.

This way, when the local control unit is in stand-by, the electricity consumption of the electric accumulator is reduced to a minimum.

In particular, in the stand-by state the local control unit deactivates any activity except the connection with the motion sensor, in order to save electricity while at the same time ensuring that is possible to switch to the activity state.

Advantageously, the landing plane passes between an inactive geometry and an active geometry and in the active geometry the control unit remains permanently in the activity state.

In particular, the mobile platform can be configured in such a way that, when the control unit goes into the active state due to accelerations detected by the motion sensor, if the landing plane passes into the active geometry within a predetermined time then the control unit remains in the active state even in the absence of detected accelerations, otherwise the control unit returns to the stand-by state.

Advantageously, quick coupling means is provided arranged to allow a removable fastening of the landing plane to an external support.

In particular, the quick coupling means comprises at least one belt. Such a belt can allow, for example, the removable connection between the mobile platform and a balcony railing.

Advantageously, a sensor is provided to detect that the coupling means is in a stable closing configuration, so that a signal is emitted that allows the user to make sure that the platform does not inadvertently release from the external support.

According to another aspect of the invention, a system is claimed for the aerial delivery of a load comprising:
a mobile platform according to one of the claims from 1 to 5;
at least one drone;
a remote control unit arranged to remotely exchange data with the mobile platform and with said or each drone;
whose main feature is that the remote control unit is arranged to:
detect the status of correct positioning generated by the local control unit;
send to said or each drone a command of delivery in the landing plane.

In particular, the remote control unit can communicate with a smartphone or tablet application, which allows the user to monitor the delivery status and carry out specific commands.

Advantageously, the mobile platform comprises a marker located in the landing plane and said or each drone is arranged, following the command of delivery, to identify the marker as a predetermined point for landing or delivering the load.

In particular, the mobile platform comprises a motion sensor suitable for detecting accelerations of the mobile platform beyond a predetermined threshold.

Advantageously, the local control unit is arranged to generate a status of unsafe landing when the motion sensor detects accelerations of the mobile platform after that the local control unit has generated the status of correct positioning.

In particular, the remote control unit is arranged to send a non-landing command to said or each drone following the generation of the status of unsafe landing.

This allows the system to detect the presence of adverse weather phenomena, such as wind or rain, and prevent a landing potentially harmful to the drone, the platform or the package being transported.

In particular, the remote control unit puts the drone on hold for a certain amount of time. If, at the end of this time interval, the landing continues to be unsafe, the remote control unit can decide whether to allow delivery without landing the drone or to reschedule the delivery.

Advantageously, the mobile platform comprises a GPS sensor adapted to detect an absolute position of the mobile platform.

This allows the system to know approximately the position of the platform and associate it with a predetermined position to be communicated to the drone for landing. For example, the GPS sensor can provide a position with an uncertainty in the order of one meter, which the system identifies as being close to a landing position that it has in memory and of which it knows the precise coordinates to be provided to the drone.

In particular, a passive RFID transponder is provided arranged to be placed at a predetermined delivery point, and the mobile platform comprises a proximity sensor arranged to detect when the mobile platform is located within a determined distance d from the passive RFID transponder.

This way, the local control unit can generate the correct positioning status when, in addition to a correct spatial orientation, the mobile platform is also in the correct point for the drone landing.

In particular, the system includes connection means designed to allow a stable connection between the drone and the platform, in the event of the drone landing.

In particular, these connection means can be of the mechanical and/or magnetic and/or electromagnetic type.

Advantageously, the connection means can also allow energy recharging of the drone battery by means of the accumulator placed in the platform.

### BRIEF DESCRIPTION OF THE DRAWINGS

Further characteristic and/or advantages of the present invention are more bright with the following description of an exemplary embodiment thereof, exemplifying but not limitative, with reference to the attached drawings in which:

FIG. 1 shows a possible embodiment of the system for the aerial delivery of a load, according to the present invention;

FIG. 2 shows a possible flow diagram of the operations carried out by the system according to the present invention;

FIGS. 3A and 3B show a possible embodiment of the invention, in which the mobile platform can switch between an open configuration and a closed configuration, significantly reducing its volume;

FIGS. 4A, 4B and 4C show three possible ways of anchoring the mobile platform of FIGS. 3A and 3B.

### DESCRIPTION OF A PREFERRED EXEMPLARY EMBODIMENT

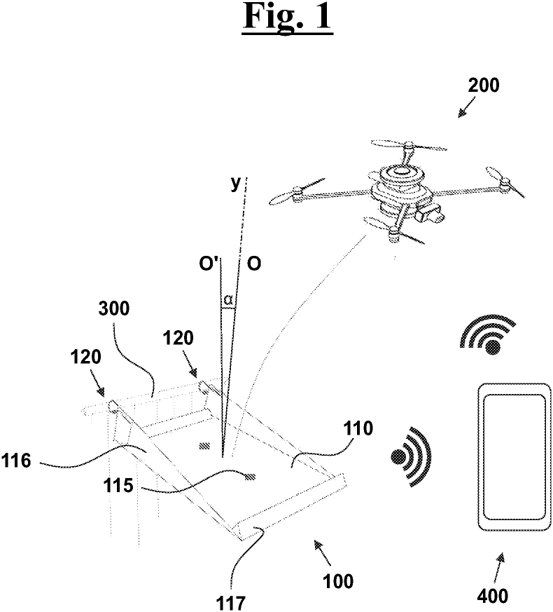

With reference to FIG. 1, the system for the aerial delivery of a load, according to the present invention, comprises a mobile platform 100 comprising a landing plane 110 defining a vertical axis y, at least one position sensor arranged to measure a spatial orientation 0 of the vertical axis y with respect to a predetermined reference system S, a local control unit connected to said or each motion sensor and an electric accumulator suitable for providing electric energy to said or each sensor and to the local control unit.

In a possible exemplary embodiment of the invention, the local control unit is arranged to pass between an activity state and a stand-by state, where the electricity consumption of the electric accumulator is reduced to a minimum.

In particular, the mobile platform 100 can further comprise a motion sensor suitable for detecting accelerations of the platform beyond a predetermined threshold, in such a way that the local control unit autonomously passes into the stand-by state when the motion sensor does not detect accelerations of the mobile platform 100 for a predetermined period of time Δt. In the stand-by state, the local control unit reduces each energy consumption but keeps the connection with the motion sensor, in order to pass again in the activity state when the sensor detects a movement of the platform 100.

This way, the platform 100 can be activated automatically when a user moves it from its rest position to place it at the point of delivery of the load.

Advantageously, the landing plane 110 can switch between an inactive geometry and an active geometry and the local control unit can exit the stand-by state when the landing plane is in the active geometry. For example, in a possible embodiment, the mobile platform 100 can comprise containing fins 116 and 117 and the passage of the landing plane 110 in the active geometry occurs by lifting these fins. This way, when the containment flaps 116 and 117 are raised, it is ensured that the released load does not come out of the landing surface 110 and the control unit can go into the active state to prepare for delivery.

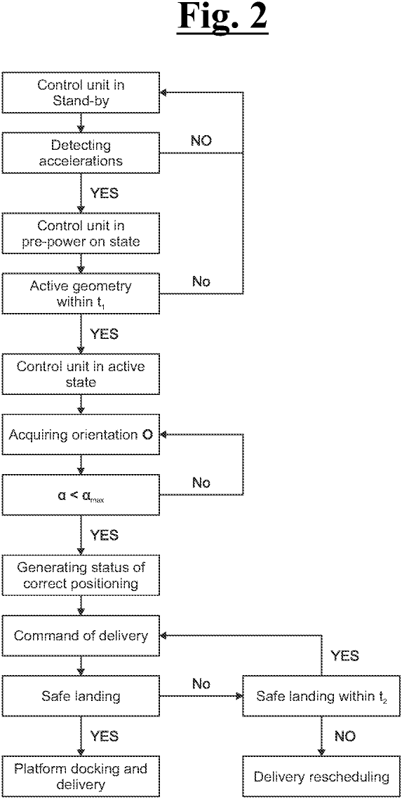

In a preferred exemplary embodiment, described in FIG. 2, the transition between inactive geometry and active geometry can be combined with the motion sensor. In this solution, the control unit passes from the stand-by state to a pre-power on state when the motion sensor detects accelerations of the platform 100. If the landing plane 110 passes into the active geometry within a time t₁, the unit control switches to the active state, otherwise it returns to the stand-by state.

In a possible embodiment, the mobile platform 100 further comprises quick coupling means 120, such as belts, suitable for allowing a removable anchoring of the landing plane 110 to an external support 300, such as, for example, a balcony railing. It can also be a sensor that verifies the correct attachment of the belts and emits a corresponding signal.

With reference even at FIG. 2, once the mobile platform 100 has been arranged at the point of delivery of the load, the local control unit is able to acquire the spatial orientation 0 of the vertical axis y and to compare the spatial orientation 0 with an orientation predetermined spatial 0′, to verify the angular deviation α. If this angular deviation is less than a predetermined value αₘₐₓ it means that the mobile platform 100 is ready to receive the load and the local control unit generates a state of correct positioning.

In a possible embodiment, the system further provides for the presence of a passive RFID transponder, able to be positioned at the desired delivery point, while the mobile platform 100 comprises a proximity sensor able to detect the distance from the RFID transponder. In this way, the local control unit can check when the mobile platform 100 is within a certain distance d from the RFID transponder, so as to generate the correct positioning status only when it verifies that both the orientation and the position of the platform 100 are correct.

In an embodiment of the invention, the platform 100 further comprises a wireless antenna, so that, when the correct positioning state is generated, the local control unit can communicate this information to a connected remote control unit to the drone 200 that has to deliver the load.

In addition, the remote control unit can be connected to a mobile device 400, such as a smartphone or tablet, which allows a user to monitor and manage the various phases of cargo delivery.

Following the generation of this state of correct positioning, the system can also command the emission of a sound, visual, vibro-tactile signal, or a combination of the above, to communicate to the user that the platform 100 is ready for receiving the load.

This signal can be commanded by the local control unit and be emitted by the mobile platform 100 and/or be commanded by the remote control unit and be emitted remotely, for example by means of the mobile device 400.

Following the generation of the correct positioning status, the remote control unit of the system is able to send the drone 200 a delivery command on the landing plane 110.

In one embodiment, the mobile platform comprises a marker 115, for example a QR code, placed on the landing plane 110 so that the drone, following the delivery command, can engage the platform 100 identifying the marker as a predetermined point for landing or delivering of load.

In one embodiment, the mobile platform 100 comprises a motion sensor adapted to detect accelerations of the mobile platform beyond a predetermined threshold and the local control unit is adapted to generate an unsafe landing state when the motion sensor detects accelerations of the mobile platform 100 after the local control unit has generated the correct positioning status.

This allows the system to detect the presence of adverse weather phenomena, such as wind or rain, and prevent a potentially harmful landing for the drone, platform or package being transported.

In particular, the remote control unit puts the drone on hold for a certain time interval t₂. If, at the end of this time interval t₂, the landing continues to be unsafe, the remote control unit can decide whether to allow delivery without landing the drone or to reschedule the delivery.

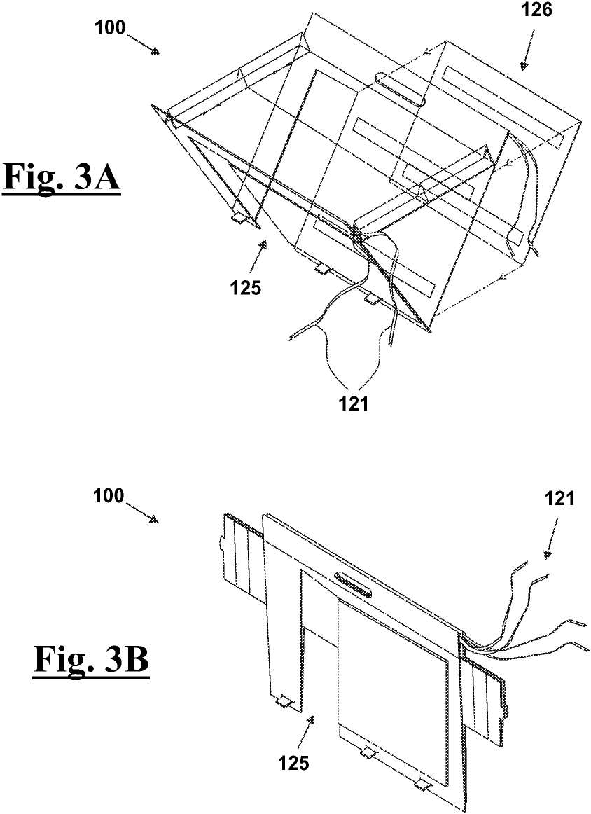

With reference to FIGS. 3A and 3B, in a possible embodiment of the invention, the mobile platform 100 is configured in such a way as to pass between a closed configuration, in which the overall volume is reduced, and an open configuration, in which the platform is ready for placement at the landing point.

In this way, in the closed configuration, the mobile platform 100 can be easily stored when not in use, or transported to the place where it is desired to land the drone.

In particular, in the closed configuration the landing plane 110 can be in the inactive geometry, while in the open configuration the landing plane can be in the active geometry. In this way, the opening of the platform 110 causes the simultaneous activation of the control unit can be activated, speeding up the procedure for setting up the platform 100 in the landing area.

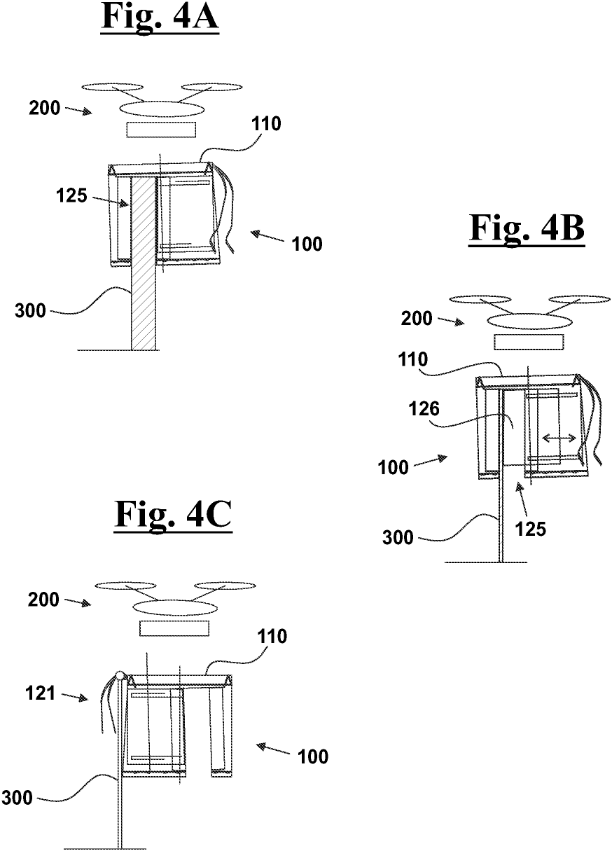

Furthermore, with reference also to FIG. 4A, this embodiment provides a V-shaped support in which a cavity 125 is obtained which, in the open configuration, allows the mobile platform 100 to be anchored to an external support 300, such as for example a parapet of a balcony.

With reference to FIGS. 3A and 4B, in order to adapt to different thicknesses of the external support 300, this embodiment also provides for the presence of a sliding plate 126 able to translate parallel to the wall of the V-shaped support, so as to reduce the thickness of the cavity 125 according to the needs.

With reference to FIG. 4C, this embodiment can also provide for the presence of laces 121 adapted to allow anchoring to the external support 300, in the event that the conformation of the support 300 does not allow stable fixing through the cavity 125, as for example in case of a railing.

1. A mobile platform (100) for the aerial delivery of a load by drones comprising:
a landing plane (110) defining a vertical axis y;
at least one position sensor arranged to measure a spatial orientation 0 of said vertical axis y with respect to a predetermined reference system S;
a local control unit connected to said or each position sensor;
an electric accumulator suitable for providing electric energy to said or each position sensor and to said local control unit;
said mobile platform (100) characterised in that said local control unit is arranged to:
acquire said spatial orientation 0 of said vertical axis y;
compare said spatial orientation 0 of said vertical axis y with a predetermined spatial orientation 0′;
generate a status of correct positioning when between said spatial orientation 0 and said predetermined spatial orientation 0′ there is an angular deviation a lower than a predetermined value αₘₐₓ;
in that at least one motion sensor is provided, suitable for detecting accelerations of said mobile platform (100) beyond a predetermined threshold, and in that said local control unit is furthermore arranged to:
going into a stand-by state when said motion sensor does not detect accelerations of said mobile platform (100) for a predetermined period of time Δt;
being in an activity state when said motion sensor detects accelerations of said mobile platform (100).

2. The mobile platform (100), according to claim 1, wherein an antenna is provided for wireless communication of data by said local control unit.

3. The mobile platform (100), according to claim 1, wherein said local control unit is also arranged to command the emission of a signal of correct positioning following the generation of said status of correct positioning.

4. The mobile platform (100), according to claim 1, wherein said landing plane (110) is adapted to pass between an inactive geometry and an active geometry and wherein in said active geometry said control unit remains permanently in said activity state.

5. The mobile platform (100), according to claim 1, wherein quick coupling means (120) are provided arranged to allow a removable fastening of said landing plane (110) to an external support (300).

6. A system for the aerial delivery of a load comprising:
a mobile platform (100) according to any of claims from 1 to 5;
at least one drone (200);
a remote control unit arranged to remotely exchange data with said mobile platform (100) and with said or each drone (200);
said system for the aerial delivery characterized in that said remote control unit is arranged to:
detect said status of correct positioning generated by said local control unit;
send to said or each drone (200) a command of delivery on said landing plane (110).

7. The system for the aerial delivery of a load, according to claim 6, wherein said mobile platform (100) comprises a marker (111) located on said landing plane (110) and wherein said or each drone (200) is arranged, following said command of delivery, to identify said marker as a predetermined point for landing or delivering said load.

8. The system for the aerial delivery of a load, according to claim 6, wherein said mobile platform (100) comprises a motion sensor suitable for detecting accelerations of said mobile platform (100) beyond a predetermined threshold, wherein said local control unit is arranged to generate a status of unsafe landing when said motion sensor detects accelerations of said mobile platform (100) after that said local control unit has generated said status of correct positioning, and wherein said remote control unit is arranged to send a non-landing command to said or each drone (200) following the generation of said status of unsafe landing.

9. The system for the aerial delivery of a load, according to claim 6, wherein said mobile platform (100) comprises a GPS sensor suitable for detecting an absolute position of said mobile platform (100).

10. The system for the aerial delivery of a load, according to claim 6, wherein it a passive RFID transponder is provided arranged to be placed at a predetermined delivery point, and wherein said mobile platform (100) comprises a proximity sensor arranged to detect when said mobile platform (100) is located within a determined distance d from said passive RFID transponder.
